(19) United States
(12) Patent Application Publication
(10) Pub. No.: US 2017/0194695 A1
(43) Pub. Date: Jul. 6, 2017

(54) ANTENNA DEVICE AND MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Junyi WANG, Beijing (CN); Lishan HUANG, Beijing (CN); Bo CHENG, Beijing (CN)

(21) Appl. No.: 15/244,816

(22) Filed: Aug. 23, 2016

Related U.S. Application Data
(63) Continuation of application No. PCT/CN2016/088832, filed on Jul. 6, 2016.

(30) Foreign Application Priority Data
Jan. 6, 2016 (CN) 2016100085329

(51) Int. Cl. H01Q 1/24; H01Q 1/36; H01Q 1/48

(52) U.S. Cl. CPC H01Q 1/243; H01Q 1/48; H01Q 1/36

(57) ABSTRACT

Disclosed are an antenna device and a mobile terminal. The antenna device comprises a radiation unit and a grounding unit, the said radiation unit comprises a first radiation unit and a second radiation unit which are connected to each other, the said grounding unit is an outer frame structure which is provided with an opening, the said second radiation unit is located inside the said outer frame structure, the said first radiation unit is located inside the said opening, both end faces of the said first radiation unit are in line with the direction of the extension of the said opening, both end faces of the said first radiation unit are isolated from both end faces of the said opening to form a first gap and a second gap respectively, and the said first radiation unit is connected to a feed point.

### CROSS REFERENCE TO RELATED APPLICATIONS

The present application is a continuation of PCT application which has an application number of PCT/CN2016/088832 and was filed on Jul. 6, 2016. The present application claims the priority of a Chinese patent application titled “an Antenna Device and Mobile Terminal”, which was filed with the Chinese Patent Office on Jan. 6, 2016 and has an application number of 201610008532.9, the contents of which are incorporated by reference herein in its entirety.

### TECHNICAL FIELD

The present application relates to communication technology, antenna devices and mobile terminals in particular.

### BACKGROUND

In modern lives, a mobile terminal, for example a mobile phone or a tablet, is an indispensable means for communicating and having entertainment; it greatly affects everyone's everyday life and work. An antenna, as a signal transmitting and receiving device for mobile terminals, directly affects the quality of communication and thereby affects our efficiency of work.

Nowadays, mobile terminal manufacturers offer mobile terminals with a metallic housing. Mobile terminals with a metal housing (i.e. the housing with the texture of metal) have attracted many users and deserved positive comments because of its fashionable and appealing appearance and the texture of metal. Mobile terminals with a metallic housing have already become the mainstream and established a trend of future development in this industry.

The metallic housing usually comprises a metallic outer frame and a metallic back cover. The metallic outer frame is set on the outer periphery of a mobile terminal, for example that a protective unit which is set on the outer periphery of a mobile phone and, together with a mobile phone screen and a back cover, form a protection structure for receiving and protecting components inside the phone. In related prior art, grounding of an antenna solution for the said metallic outer frame is usually achieved by coupling the antenna directly to a ground point on a printed circuit board (PCB).

However, the inventor of the present application finds that such grounding structure requires a slit (i.e. a gap) on the metallic outer frame in order to have a width greater than 1.0 mm to ensure the mobile phone antenna to achieve a good bandwidth and performance. Otherwise the bandwidth and performance of the antenna can be directly affected due to excessive gap coupling. In the prior art, the antenna and the metallic outer frame are configured inside the metallic outer frame and spaced apart from each other; both transmitting and receiving of magnetic waves have to be through the said slit. The state of coupling of the slit (namely, dimensions of the slit and the like) therefore directly affects signaling of the antenna, and would even give rise to a shielding effect if the gap of the antenna was too small.

There is no antenna design which has managed to cater to the bandwidth and performance of an antenna while ensuring reduction of the width of the gap.

In another aspect, antennas in the prior art, due to limitation of design dimensions, have a smaller radiation volume so that performance of such antennas is relatively weaker.

### SUMMARY

In view of the above, an object of the present application is to provide an antenna device and a mobile terminal to cater to the bandwidth and performance of the antenna while ensuring reduction of the width of the gap (i.e., reduce the coupling effect of the gap).

Another object of the present application is to provide an antenna device capable of effectively improving the radiation volume without affecting the design dimensions of the mobile terminal.

An antenna device according to the first aspect of the present application is provided, comprising: a radiation unit and a grounding unit, the said radiation unit comprises a first radiation unit and a second radiation unit, and the said first radiation unit and the said second radiation unit are connected to each other, the said grounding unit is an outer frame structure provided with an opening, the said second radiation unit is located inside the said outer frame structure, the said first radiation unit is located inside the said opening where both end surfaces of the said first radiation unit are in the direction of the extension of the said opening, both end surfaces of the said first radiation unit are isolated from the both ends faces of the said opening so as to form a first gap and a second gap respectively, where the said first radiation unit is connected to a feed point.

According to the second aspect of the present application, a mobile terminal, including the said antenna device is provided.

According to the antenna device disclosed by embodiments of the present application, because of the grounding structure formed by a metallic outer frame assembly, part of which is effectively used as a radiation unit, the antenna device can utilize, simultaneously, the gap and the metallic outer frame to transmit and receive electromagnetic signals, whereby the gap coupling effect is reduced and the radiation volume of the antenna device is increased, while the performance and bandwidth of the antenna device are both ensured. For the above reason, the bandwidth and performance of an antenna are both ensured, given that the extent of reduction of the width of the gap is the achievable minimum.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 illustrates a perspective view of the structure of an antenna device in accordance with the present application;

FIG. 2 illustrates a front view of an antenna device in accordance with the present application;

FIGS. 3-4 are diagrams of simulation performance results of the antenna device in accordance with the present application when its gap has a width of 0.5 mm;

FIGS. 5-6 are diagrams of simulation performance results of the antenna device in accordance with the present application when its gap has a width of 0.4 mm.

### DETAILED DESCRIPTION

The present disclosure will be understood more fully from the detailed description and from the accompanying drawings. Same elements in the drawings are denoted by identical or similar reference numbers. For the sake of clarity, it should be understood that the drawings are not necessarily proportional or to scale.

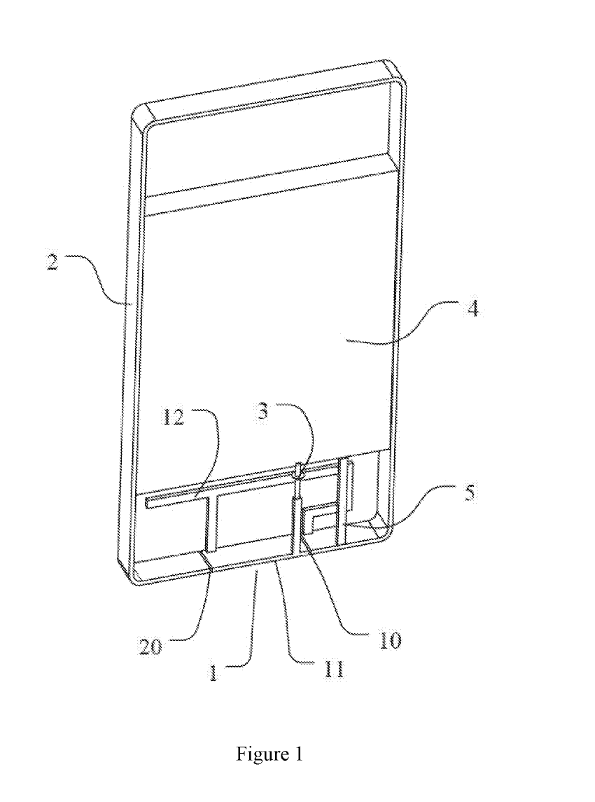

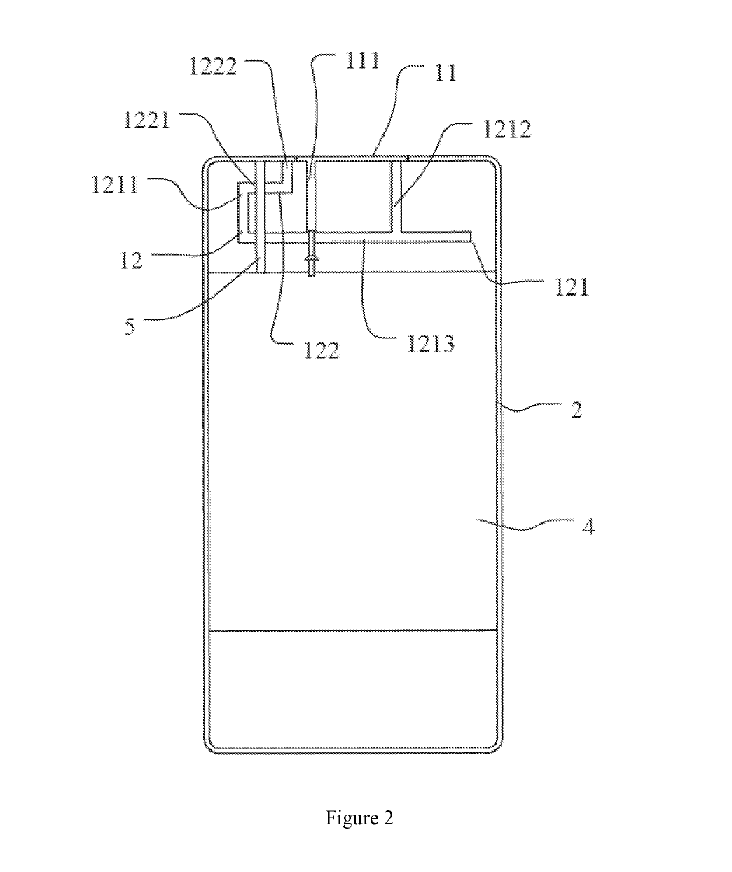

With reference to FIGS. 1-2, the antenna device in the present disclosure is an annular antenna device placed on a mobile terminal, is configured to transmit and receive signals, and comprises a radiation unit 1 and a grounding unit 2, wherein the said radiation unit 1 comprises a first radiation unit 11 and a second radiation unit 12, the first radiation unit 11 and the second radiation unit 12 are connected to each other, the said grounding unit 2 is an outer frame structure provided with an opening, the said second radiation unit 12 is located inside the said outer frame structure, the said first radiation unit 11 is located inside the said opening, where both end surfaces of the said first radiation unit 11 are in line with the direction of the extension of the said opening, both end surfaces of the said first radiation unit 11 are isolated from the both ends surfaces of the said opening to form a first gap 10 and a second gap 20 respectively, and the said first radiation unit 11 is connected to a feed point 3.

The said mobile terminal can be any suitable device having a communication function, such as a personal computer, a laptop computer, a cellular phone, a mobile phone, or a tablet.

The outer frame structure of the said grounding unit is a metallic outer frame provided with an opening, and the said first radiation unit is a metallic plate extending in length direction of the said opening. The said metallic plate and the grounding unit together form a metallic outer frame assembly of the mobile terminal, such as a metallic outer frame assembly of a mobile phone, for encapsulating internal elements of the mobile terminal.

In an optional embodiment, a device mother board 4 is placed inside the metallic outer frame assembly of the said mobile terminal, the said antenna device is located at one end of the said device mother board, where the said second radiation unit 12 is located in an antenna clearance area inside the said metallic outer frame, and the said device mother board is electrically connected to the said grounding unit 2 via a ground wire 5. This structural design utilizes part of the metallic outer frame assembly to realize grounding without modifying the original way of design and dimensions of the mobile terminal.

The said second radiation unit 12 comprises a first radiation body 121 and a second radiation body 122, wherein the said first radiation body is F-shaped, the said second radiation body is L-shaped, and one end of the said first radiation body 121 is connected to one end of the said second radiation body 122.

The said first radiation body 121 comprises a first radiation arm 1211, a second radiation arm 1212 and a third radiation arm 1213, the first radiation arm 1211 and the second radiation arm 1212 are parallel to each other, the third radiation arm 1213 connected perpendicularly to the said first radiation arm 1211 and the said second radiation arm 1212, wherein one end of the said first radiation arm 1211 is connected to one end of the said third radiation arm 1213.

The said second radiation body 122 comprises a fourth radiation arm 1221 and a fifth radiation arm 1222, the fourth radiation arm 1221 and the fifth radiation arm 1222 are perpendicularly connected to each other, wherein one end of the said fourth radiation arm 1221 is connected to one end of the said first radiation arm 1211 at a right angle, and both the said fourth radiation arm 1221 and the said third radiation arm 1213 extend towards the same direction.

The said first radiation unit 11 further comprises a sixth radiation arm 111, which extends towards the inside of the grounding unit, and is connected to the said feed point.

The said second radiation unit 12 is electrically connected to the said first radiation unit 11 via the said second radiation arm 1212. The said second radiation unit 12 is electrically connected to the said grounding unit 2 via the said fifth radiation arm 1222.

A grounding structure of the antenna device is therefore formed. The said first radiation unit 11 of such antenna device is electrically connected to the said grounding unit 2 via the said second radiation unit 12, and essentially forms a grounding structure by which the antenna device is grounded via the metallic outer frame assembly, part of which is effectively used as a radiation unit. The antenna device can utilize, simultaneously, the gap and the metallic outer frame to transmit and receive electromagnetic signals, whereby the gap coupling effect is reduced and the radiation volume of the antenna device is increased, while the performance and bandwidth of the antenna device are both ensured. For the above reason, the bandwidth and performance of an antenna are both ensured, given that the extent of reduction of the width of the gap is the achievable minimum. The range for selecting a possible width of the gap is wider, for example that to set the width of the gap between 0.4 mm and 2 mm can also achieve a good antenna performance. The effect of transmitting and receiving signals from an antenna will be also guaranteed, even if the width of the gap is set within a smaller range.

When the mobile terminal is a mobile phone, thickness of the wall of the said metallic outer frame 10 can be 0.8 mm-1.2 mm. The width of the said first gap and the said second gap may, according to actual needs, be set more than 0.35 mm, optionally 0.35 mm-2 mm. For example, the width may be set as 0.4 mm, 0.6 mm or 1.0 mm, whereupon a good antenna performance can always be ensured.

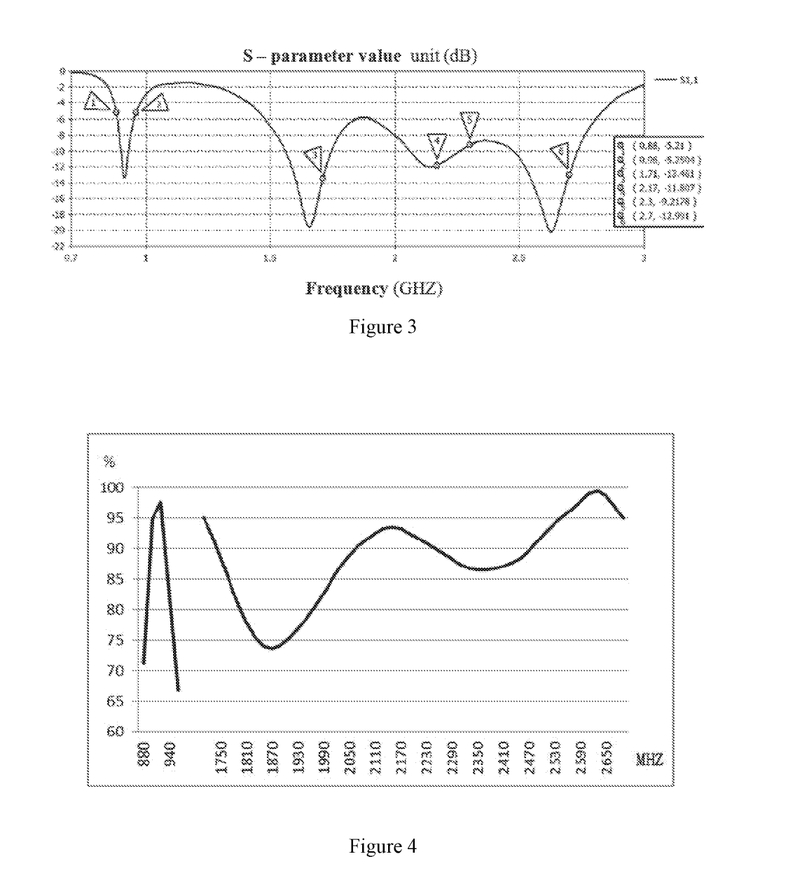

FIGS. 3-4 illustrate diagrams of simulation performance results of the antenna device when its gap has a width of 0.5 mm. In this simulation, thickness of the mobile terminal is 7 mm, the wall thickness of the said metallic outer frame is 1 mm, and width of the said first gap and the said second gap is 0.5 mm.

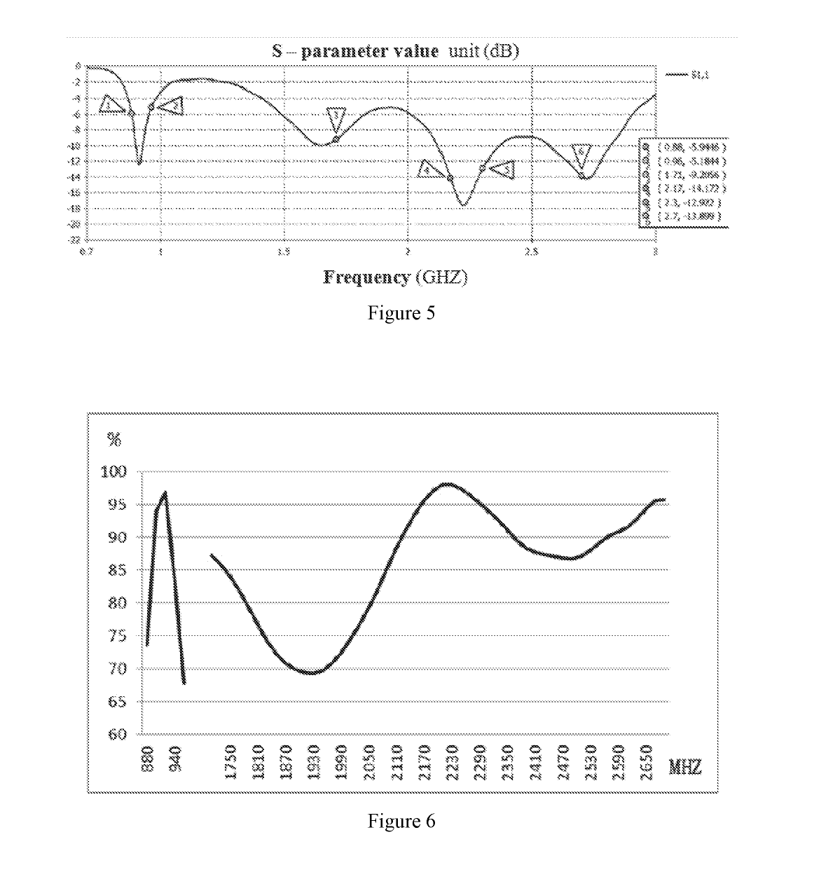

FIGS. 5-6 illustrate diagrams of simulation performance results of the antenna device when its gap has a width of 0.4 mm. In this simulation, the thickness of the mobile terminal is 7 mm, the wall thickness of the said metallic outer frame is 1 mm, and width of the said first gap and the said second gap is 0.4 mm.

As known from the simulation results within FIGS. 3-6, a return loss rate, namely, a return loss of the antenna in each of the frequency bands 880 MHZ-960 MHZ and 1710 MHZ-2700 MHZ is below −5 dB, and it has greater antenna efficiency.

It should be understood that, in this specification, terms like “first”, “second” and the like are only used to distinguish one entity or operation from another, but are not necessarily to require or imply any practical relationship or order between these entities or operations. Moreover, a term such as “comprise”, “include” or any variations of the term shall be construed as “including but not limited to”. Therefore, any process, method, object, or device that includes a series of elements not only includes these elements, but also includes other elements that are not specified expressly, or may further include inherent elements of the process, method, object or device. In case there is no further limitation, in the context of one element that is specified by “include one . . . ”, the process, method, object or device that includes a specified element may include other identical elements.

Finally, it should be understood that those skilled in the art appreciate that although some embodiments here include some features, not those described in different embodiments, combinations of features from different embodiments still fall within the scope of the present disclosure and constitute different embodiments. For example, any one of the claimed embodiments in the appended claims may be used by combination.

1-10. (canceled)

11. An antenna device, comprising: a radiation unit and a grounding unit, the said radiation unit comprises a first radiation unit and a second radiation unit, and the said first radiation unit and the said second radiation unit are connected to each other, the said grounding unit is an outer frame structure which is provided with an opening, the said second radiation unit is located inside the said outer frame structure, the said first radiation unit is located inside the said opening, both end surfaces of the said first radiation unit are in line with the direction of the extension of the said opening, both end surfaces of the said first radiation unit are isolated from both end surfaces of the said opening to form a first gap and a second gap respectively, and the said first radiation unit is connected to a feed point.

12. The antenna device according to claim 11, wherein
the said second radiation unit comprises a first radiation body and a second radiation body, the said first radiation body is F-shaped, the said second radiation body is L-shaped, and one end of the said first radiation body is connected to one end of the said second radiation body;
the said first radiation body comprises a first radiation arm, a second radiation arm and a third radiation arm, the said first radiation arm and the said second radiation arm are parallel to each other, and the said third radiation arm is perpendicularly connected to the said first radiation arm and the said second radiation arm, wherein one end of the said first radiation arm is connected to one end of the said third radiation arm;
the said second radiation body comprises a fourth radiation arm and a fifth radiation arm, and the said fourth radiation arm and the said fifth radiation arm are perpendicularly connected to each other, wherein one end of the said fourth radiation arm is connected to one end of the said first radiation arm at a right angle, and both the said fourth radiation arm and the said third radiation arm extend towards the same direction.

13. The antenna device according to claim 12, wherein the said second radiation unit is electrically connected to the said first radiation unit via the said second radiation arm.

14. The antenna device according to claim 12, wherein the said second radiation unit is electrically connected to the said grounding unit via the said fifth radiation arm.

15. The antenna device according to claim 12, wherein the said first radiation unit further comprises a sixth radiation arm which extends towards the inside of the said grounding unit and is connected to the said feed point.

16. The antenna device according to claim 11, wherein the said first radiation unit is a metallic plate.

17. The antenna device according to claim 16, wherein the said grounding unit and the said metallic plate together form a metallic outer frame assembly.

18. A mobile terminal, wherein the said mobile terminal comprises a antenna device, the said antenna device comprises a radiation unit and a grounding unit, the said radiation unit comprises a first radiation unit and a second radiation unit, and the first radiation unit and the second radiation unit are connected to each other, the said grounding unit is an outer frame structure which is provided with an opening, the said second radiation unit is located inside the said outer frame structure, the said first radiation unit is located inside the said opening, both end surfaces of the said first radiation unit are in line with the direction of the extension of the said opening, both end surfaces of the said first radiation unit are isolated from both end surfaces of the said opening to form a first gap and a second gap respectively, and the said first radiation unit is connected to a feed point.

19. The mobile terminal according to claim 18, wherein
the said second radiation unit comprises a first radiation body and a second radiation body, the said first radiation body is F-shaped, the said second radiation body is L-shaped, and one end of the said first radiation body is connected to one end of the said second radiation body;
the said first radiation body comprises a first radiation arm, a second radiation arm and a third radiation arm, the said first radiation arm and the said second radiation arm are parallel to each other, the said third radiation arm is perpendicularly connected to the said first radiation arm and the said second radiation arm, wherein one end of the said first radiation arm is connected to one end of the said third radiation arm;
the said second radiation body comprises a fourth radiation arm and a fifth radiation arm, and the said fourth radiation arm and the said fifth radiation arm are perpendicularly connected to each other, wherein one end of the said fourth radiation arm is connected to one end of the said first radiation arm at a right angle, and both the said fourth radiation arm and the said third radiation arm extend towards the same direction.

20. The mobile terminal according to claim 19, wherein the said second radiation unit is electrically connected to the said first radiation unit via the said second radiation arm.

21. The mobile terminal according to claim 19, wherein the said second radiation unit is electrically connected to the said grounding unit via the said fifth radiation arm.

22. The mobile terminal according to claim 19, wherein the said first radiation unit is further provided with a sixth radiation arm which extends towards the inside of the said grounding unit and is connected to the said feed point.

23. The mobile terminal according to claim 18, wherein the said first radiation unit is a metallic plate.

24. The mobile terminal according to claim 23, wherein the said grounding unit and the said metallic plate together form a metallic outer frame assembly.

25. The mobile terminal according to claim 18, wherein the said mobile terminal further comprises a device mother board which is electrically connected to the said grounding unit via a ground wire.

26. The mobile terminal according to claim 19, wherein the said mobile terminal further comprises a device mother board which is electrically connected to the said grounding unit via a ground wire.

27. The mobile terminal according to claim 20, wherein the said mobile terminal further comprises a device mother board which is electrically connected to the said grounding unit via a ground wire.

28. The mobile terminal according to claim 18, wherein the said mobile terminal is a mobile phone, and the width of the said first gap and the said second gap is 0.35 mm-2 mm.

29. The mobile terminal according to claim 19, wherein the said mobile terminal is a mobile phone, and the width of the said first gap and the said second gap is 0.35 mm-2 mm.

30. The mobile terminal according to claim 20, wherein the said mobile terminal is a mobile phone, and the width of the said first gap and the said second gap is 0.35 mm-2 mm.
